(19) United States
(12) Patent Application Publication
(10) Pub. No.: US 2008/0162201 A1
(43) Pub. Date: Jul. 3, 2008

(54) DISPLAYING A MODEL-BASED COMPUTER USER INTERFACE

(76) Inventor: Joachim Sander, Mannheim (DE)

Correspondence Address: SAP AG c/o BUCKLEY, MASCHOFF & TALWALKAR LLC, 50 LOCUST AVENUE, NEW CANAAN, CT, 06840, US

(21) Appl. No.: 11/617,555

(22) Filed: Dec. 28, 2006

(51) Int. Cl. G06F 17/50; G06F 3/048; G06F 9/44

(52) U.S. Cl. 705/7

(57) ABSTRACT

Techniques for displaying a user interface on a computer display device are described. The techniques include displaying, on a computer display device, a model panel in a computer user interface where the model panel corresponds to one of an academic model or an industry model. The displayed model panel includes model components. User input that requests access to information related to one of the model components is received. Information related to the one of the model components in a second panel in the computer user interface is played on the computer display device. The second panel and the model panel are able to be viewed concurrently in the computer user interface.

### TECHNICAL FIELD

This description relates to displaying a model-based computer user interface.

### BACKGROUND

Computer systems often are used to manage and process business data. To do so, a business enterprise may use various application programs running on one or more computer systems. Application programs may be used to process business transactions, such as taking and fulfilling customer orders, providing supply chain and inventory management, performing human resource management functions, and performing financial management functions. Application programs also may be used for analyzing data, including analyzing data obtained through transaction processing systems. In many cases, application programs used by a business enterprise are developed by a commercial software developer for sale to, and use by, many business enterprises.

Many user interfaces allow users to review, edit or enter data on a number of different panels displayed by a computer system. Some computer systems enable a user to navigate back and forth between panels at will to review, edit and enter data. Computer systems may require multiple users to review, edit or enter related data. Some users may perform different roles and functions within a computer system, and users having different roles may need to work together to process a transaction within the computer system.

### SUMMARY

In one general aspect, a user interface is displayed on a computer display device. A model panel is displayed, on a computer display device, in a computer user interface where the model panel corresponds to one of an academic model or an industry model. The displayed model panel includes model components. User input that requests access to information related to one of the model components is received. Information related to the one of the model components in a second panel in the computer user interface is played on the computer display device. The second panel and the model panel are able to be viewed concurrently in the computer user interface.

Implementations may include one or more of the following features. For example, user input requesting access to information related to a second model component of the model components may be received. The second panel may cease to be displayed, and information related to the second model component may be displayed on the computer display device in a third panel in the computer user interface such that the third panel and the model panel are able to be viewed concurrently in the computer user interface.

Information related to each of the model components may be accessible to be displayed when the model panel is able to be viewed in the computer user interface. Each of the model components may be operable to display information related to the model component.

User input identifying a subject of information to be displayed in the computer user interface may be received. A determination may be made as to whether each model component is able to display information related to the subject of information. Based on the determination, a first presentation style may be used for model components for which information related to the subject information is able to be displayed and a second, different presentation style may be used for model components for which information related to the subject information is not able to be displayed.

A control may be displayed proximate to a model component, where the control is operable to display a subset of information related to the model component.

Implementations of any of the techniques described above may include a method or process, an apparatus or system, or computer software on a computer-accessible medium. The details of particular implementations are set forth in the accompanying drawings and description below. Other features will be apparent from the following description, including the drawings, and the claims.

### DESCRIPTION OF DRAWINGS

FIG. 1 is a block diagram of a computer system capable of displaying a user interface providing a model-based navigation pattern.

FIGS. 2 and 3 are block diagrams of user interfaces providing model-based navigation patterns.

FIG. 4 is a flow chart of a process for displaying a user interface providing a model-based navigation pattern.

FIGS. 5-7 schematically show an example user interface providing a model-based navigation pattern.

Like reference symbols in the various drawings indicate like elements.

### DETAILED DESCRIPTION

Techniques are described for a user interface providing a model-based navigation pattern of multiple displays in a computer system. The navigation pattern of multiple displays represents and directly relates to a generally known model. Presenting a user interface having a model-based navigation pattern may facilitate a user's comprehension of a collection of related data. The navigation pattern of multiple displays may be used in addition to, or in lie of, an application user interface that otherwise would be used to review, edit or enter data in a computer system. A model-based navigation pattern may be useful to enable a user who is not generally familiar with an application program to interact with data available through the application program.

A user interface that represents a generally known model of a business or business process may enable a user to more easily understand and navigate a large or complex collection of computer data. In one example, an executive of an organization may not commonly enter business data through an application user interface and may not be familiar with how to navigate through application user interfaces to review or edit data. The executive, however, may be familiar with an academic or industry business model that may be used to present or represent the business data entered through the application. In such a case, it may be advantageous to provide a user interface to business data using a model-based navigation pattern that represents a generally known academic or industry business model.

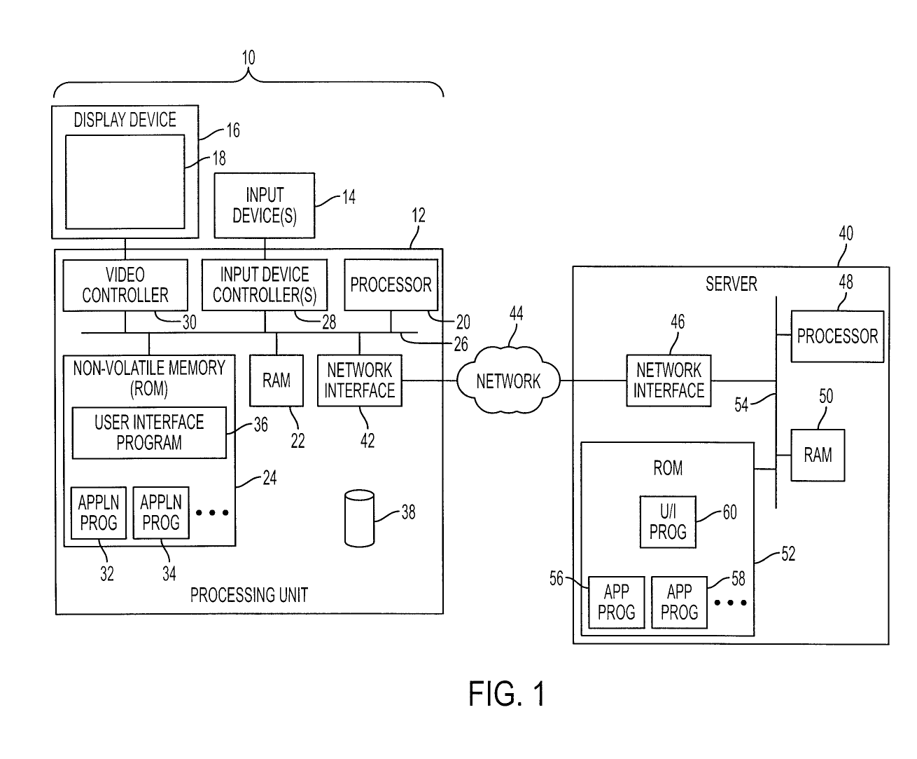

Referring to FIG. 1, a computer system 10 includes a processing unit 12, one or more input devices 14, and a display device 16 that may present displays of a user interface to a user. The display device 16 has a screen 18 upon which the displays may appear. The system 10 is capable of presenting a user interface with enhanced navigation through displayed panels on the display device 16 as described below.

The processing unit 12 includes a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The computer system 10 is not limited to a personal computer, but could instead include a personal digital assistant, a terminal, a workstation, or other such device.

ROM 24, as is conventional, may provide non-volatile data storage for various application programs 32, 34, etc. Programs 32 and 34 have program instructions that may be loaded into RAM 22 during operation. Processor 20 may then execute the program instructions, as required, to perform particular program functions. Also stored in ROM 24 is a model-based user interface program 36 that may be designed to work in concert with each of the application programs 32, 34, etc. This is conceptually depicted in FIG. 1 by the user interface program 36 being shown as a layer on top of the application programs 32, 34, etc.

With such a design, user interface program modules common to several application programs need not be duplicated in each of the application programs. The user interface program 36 may create a display of a model-based navigation pattern of displays to be presented to a user on screen 18 of display device 16. The user may interact with the display by providing input using an input device 14, such as a mouse, keyboard, light pen, touchpad, joystick, etc. The user interface program 36 may use the received input to take appropriate actions, such as updating the display, creating a new display, interacting with applications programs 32 and/or 34, accessing a database 38, or accessing server 40 (described below), to list just a few examples. In other implementations, the user interface program 36 need not be a common program or module for more than one program application. Also, the components just described could be combined or separated in various manners, and could be stored in various manners, such as on various non-volatile storage medium.

Also shown in FIG. 1 is server 40. The computer system 10 may access server 40 to run applications residing on the server 40. The computer system 10 may do so by using a network interface 42 connected to its data bus 26 to access a network 44. Network 44 may be, for example, a local area network (LAN), wide area network (WAN), or a network that allows the computer system 10 and the server 40 to be part of the Internet. As is conventional, the server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, etc., as well as a common user interface program 60 for the application programs 56, 58, etc. User interface program 60 may operate similarly to user interface program 36. Any of the entities described above in the server ROM 52 could alternatively be located in a separate server, database, or computer system.

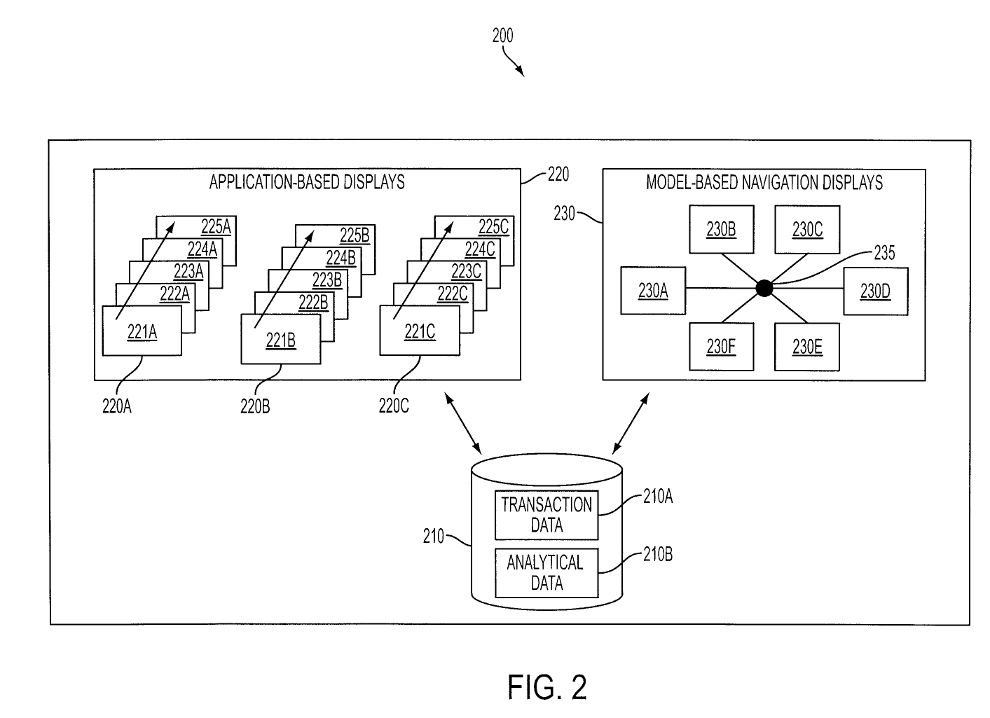

FIG. 2 illustrates a schematic representation 200 of displaying business data 210 in both an application user interface 220 and a user interface 230 providing a model-based navigation pattern. The business data 210 includes transaction data 210A, such as, for example, data representing sales orders, purchase orders, delivery orders, customers, suppliers, employees and work flow data related to document processing. Some implementations may make a distinction between master data and processing data in transaction data 210A. Transaction data that represents principal entities and documents (such as data representing sales orders, purchase orders, delivery orders, customers, suppliers, and employees) may be referred to as master data. Transaction data that includes transient processing data, such as workflow data or approval data may be referred to as processing data. The business data 210 may include analytical data 210B, such as analytical data generated and stored in a data warehouse.

As illustrated, the business data 210 may be reviewed, edited and entered using application-based displays 220 that are generated by application programs. Application programs, for example, may include a customer relationship management application program, a supply chain management application program, an inventory management application program, a human resource management application program and a financial management application program. In some cases, application programs may have complex user interfaces that require a user to have significant experience to understand and efficiently use. For example, a user interface for an application program may be designed to enable efficient operation by users of performing a function on a routine basis.

In the example of FIG. 2, the application-based displays 220 include a series of displays 220A for entering, editing and reviewing sales orders, a series of displays 220B for entering, editing and reviewing purchase orders, and a series of displays 220C for inventory management. The application-based displays 220A, 220B and 220C each present sequential displays such that, for example, a user must navigate through displays 221A, 222A, 223A and 224A before reaching display 225A.

The business data 210 may be reviewed, edited and entered using a user interface 230 based on a model-based navigation pattern 230A, 230B, 230C, 230D and 230E. In the example of model-based navigation displays 230, the displays represent a generally known academic business process model. For example, the model may be a generally known business process model that represents the general relationship common among business enterprises between purchasing, inventory management, production, sales and financial management. One example of such a model is Michael Porter's value chain model.

In contrast to sequential application-based displays 220A, 220B and 220C, each of the model-based navigation pattern displays 230A-230F may be accessed by a user from any other model-based navigation pattern displays 230A-230F, as represented by the circle 225.

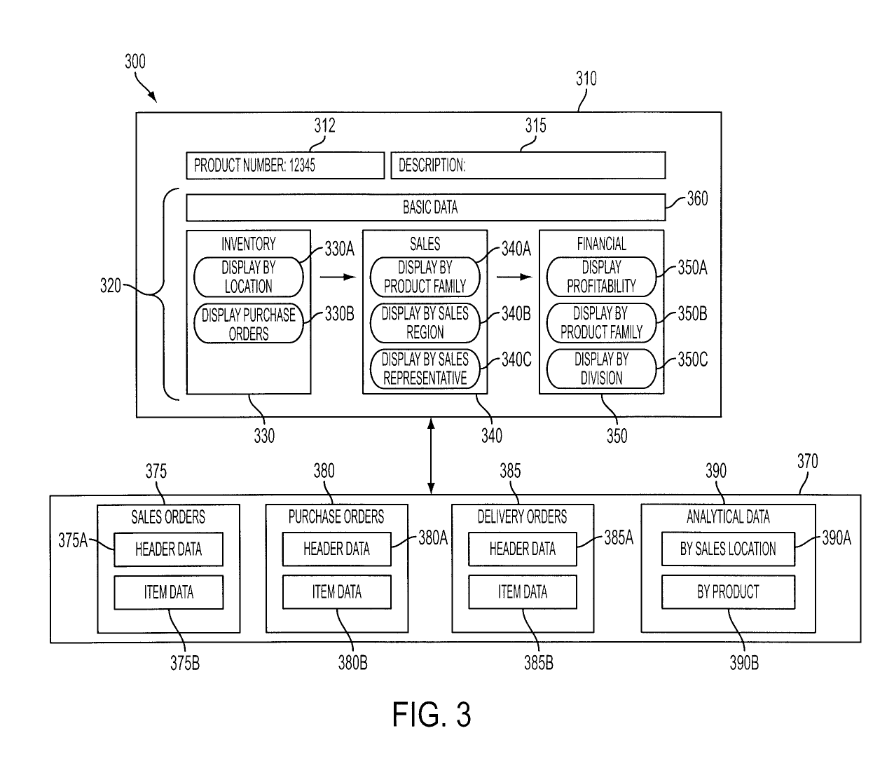

FIG. 3 illustrates another example schematic representation 300 of a user interface 310 based on a model-based navigation pattern. The user interface 310 may be displayed, for example, on a display device 16 of a computer system 10, as previously described with respect to FIG. 1.

The user interface display 310 includes product information (here, a product number 312 and a product description 314) identifying a particular product to which the display 310 applies. The display 310 also includes controls 320 that enable a user to display information related to the particular product based on a generally known model (rather than through various application user interfaces that could be used to enter, edit or review the product information). In this example model, the model, including the model components, is generally known and includes an inventory component, a sales component and a financial component. The controls 320 include controls 330A and 330B that correspond to the model's inventory component, controls 340A-330C that correspond to the model's sales component and controls 350A-350C that correspond to the model's financial component. The controls 320 of the display 310 also include a basic data control 360 operable to display basic data about the particular product, such as, for example, a catalog description or types of technical information.

The controls 330A-350C are operable to display information from business data 370. In this example, the business data 370 is stored in a relational database and includes sales order data 375 organized as a header data table 375A and an item data table 375B. The business data 370 also includes purchase order data 380 (organized as a header data table 380A and an item data table 380B) and delivery order data 385 (organized as a header data table 385A and an item data table 385B). The business data 370 also includes analytical data 390 generated by various analytical processes and organized as sales location data tables 390A and product data tables 390B.

In this simplified example, a user may be able to more easily comprehend the complex business data 370 when presented through navigation displays based on a generally well-known model (as compared with comprehension through application-based displays). More particularly, the user is able to display inventory information related to the particular product by inventory location (by activating control 330A) and by purchase order (by activating control 330B). The user is able to display sales information related to the particular product by product family (by activating control 340A), by sales region (by activating control 340B), or by sales representative (by activating control 340C). The user is able to display financial information related to the particular product by profitability factors (by activating control 350A), by product family (by activating control 350B) and by division (by activating control 350C).

In sum, the controls 330, 340 and 350, in this example, enable the user to view information related to the particular product based on a generally known model. The display 310 helps to orient the user quickly to information that may be displayed and provides the user with quick access to critical data. In contrast to using application-based displays, the user of display 310 may be able to retrieve data without navigating through multiple displays to locate data important to the user.

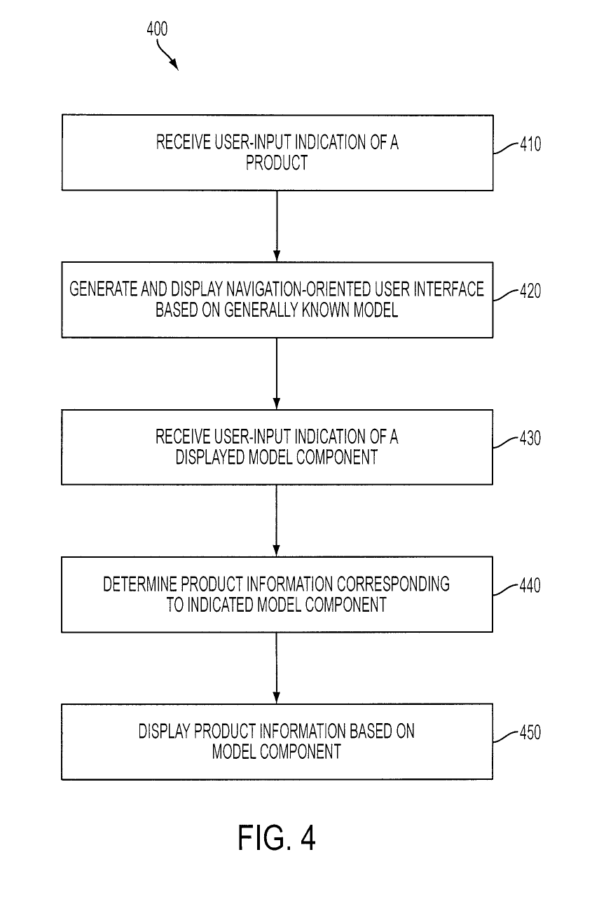

FIG. 4 depicts an example process 400 for providing a user interface having a navigation pattern based on a generally known model. The example process 400 may be implemented in computer-readable medium that is executed by, for example, a processor (or processors) of the server 40 described previously with respect to FIG. 1.

The process 400 begins when the system implementing the process 400 receives a user-input indication of a product for which the navigation pattern is to be generated (step 410). This may be accomplished, for example, by a user entering a product identifier (such as a product identification number, a product name or a product description) to a computer system, or selecting a product identifier from a list of product identifiers.

The system performing the process 400 generates and displays, on a computer display device, a navigation-oriented user interface that is based on a generally known model (step 420). The displayed model includes model components operable to, when activated by user-input, display product information for the indicated product based on the model component. The system receives a user-input indication of a displayed model component (step 430). For example, a user may use a pointing-device to activate a control corresponding to a model component. The system determines product information corresponding to the indicated model component (step 440). This may be accomplished, for example, by accessing information that identifies data elements of a product that relate to the indicated model component. The system displays product information based on the model component (step 450). For example, the system generates and displays a user interface including the data elements identified in step 440.

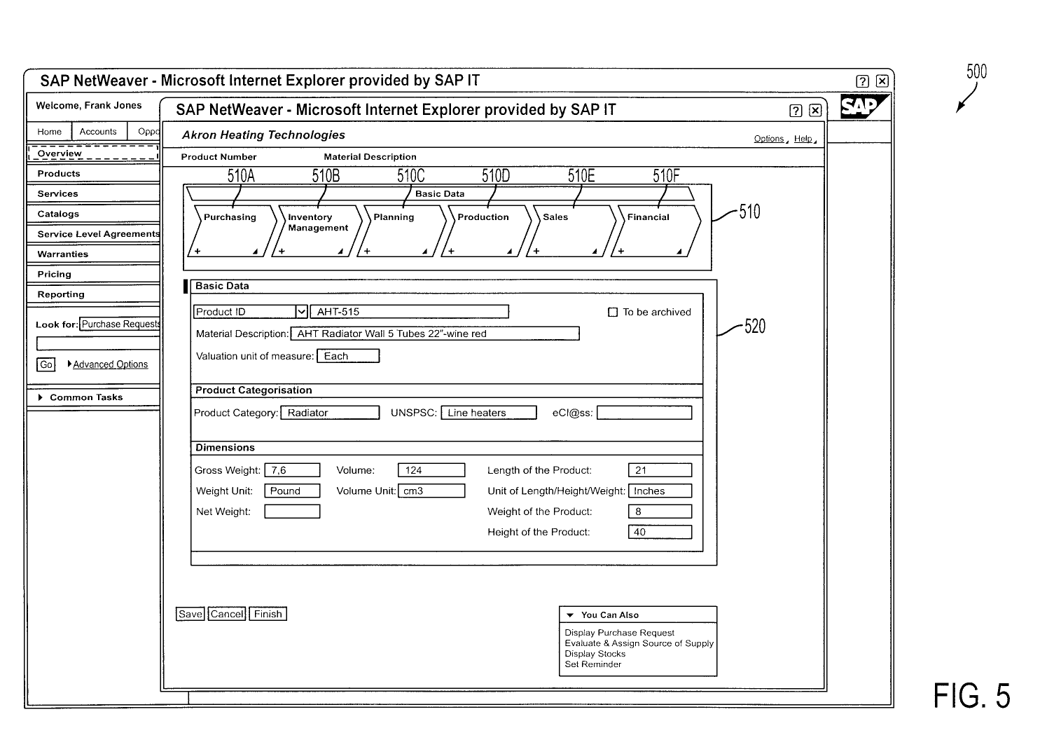

FIGS. 5-7 present a series of user interfaces 500-700 illustrating a navigation pattern based on the value chain model developed by Michael Porter. FIG. 5 represents a user interface 500 having a model panel 510 and a basic data panel 520. The model panel 510 displays the value chain model components: purchasing 510A, inventory management 510B, planning 510C, production 510D, sales 510E and financial 510F. The model panel 510 also includes a basic data control 512. As illustrated, the basic data control 512 is selected, and basic data for a particular product is displayed in the basic data panel 520.

In the example user interface 500, the model components 510A-510F are not operable to display product information until a particular product is selected. Once a particular product is identified, the model components 510A-510F for which data is available are operable to display product information that is relevant to the selected model component.

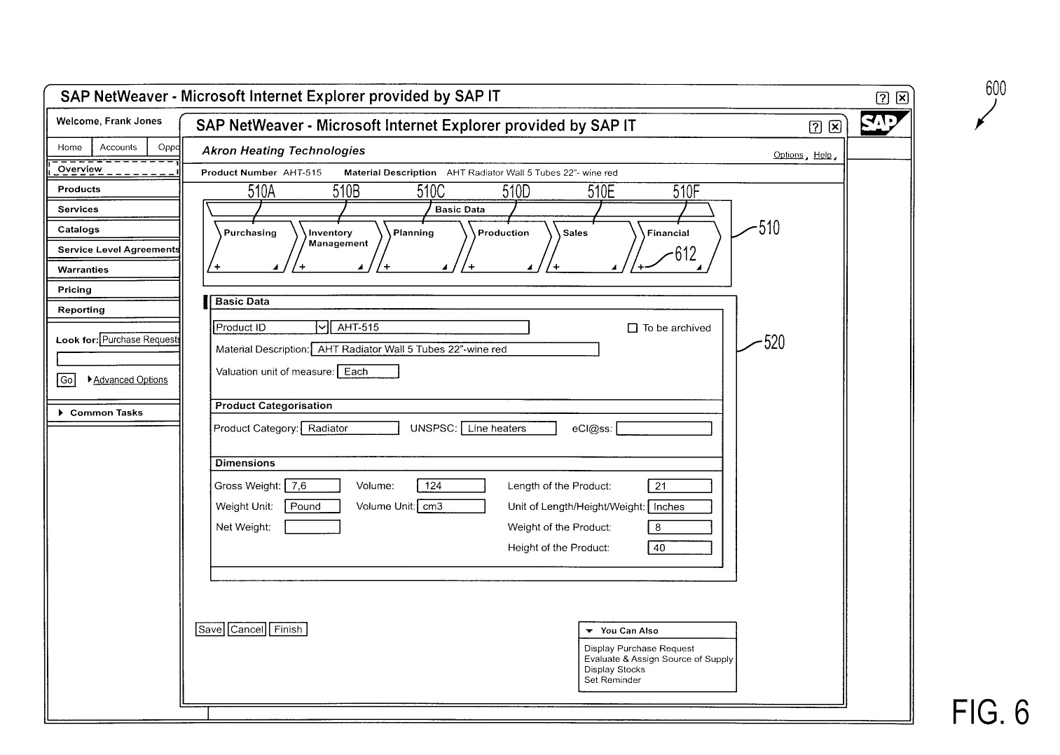

Referring to FIG. 6, the user interface 600 illustrates model components 510B-510F as being activated or available—that is, operable to display relevant product information for a selected model component. By contrast, the user interface 600 shows purchasing model component 510A as being inactive or unavailable for use to display product information. The visual clue of whether information is available for each model component may be helpful to orient a user and help a user retrieve desired information about a product.

Each model component 510A-510F includes a show control represented by a plus sign (such as shown control 612 for the financial model component 510F). When activated, the show control displays additional controls to display product information related to the model component to which the show control applies.

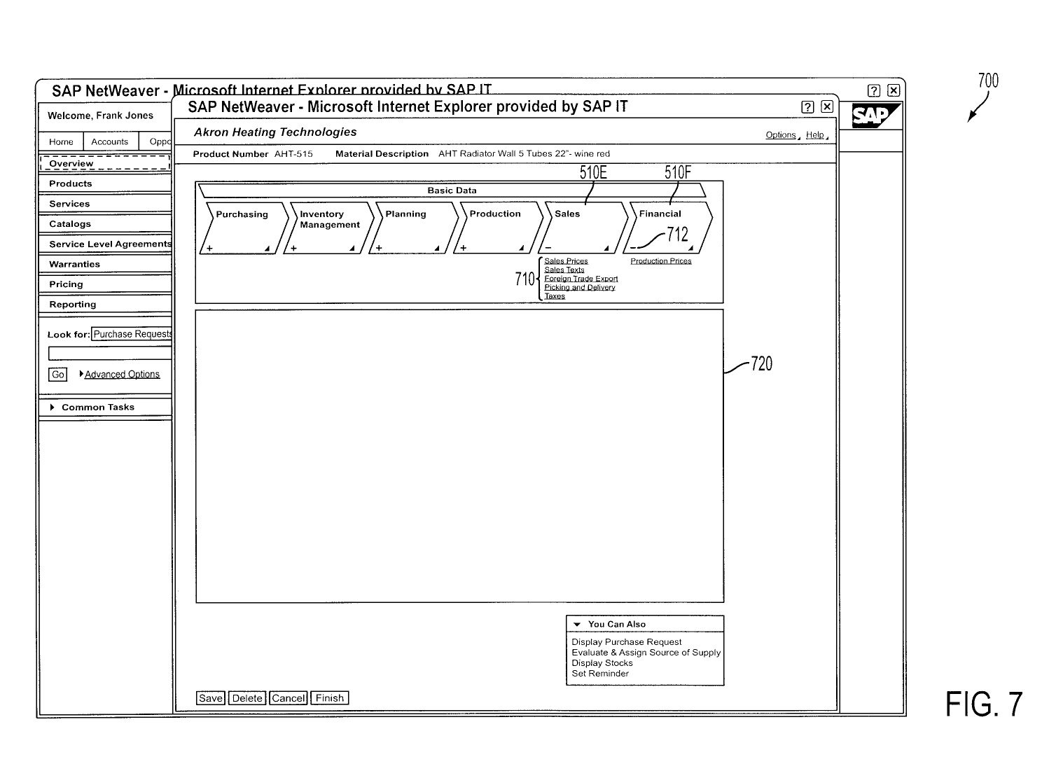

As illustrated in FIG. 7, the show control of the sales model component 510E and the show control of the financial model component 510F have been activated. As a result, additional controls 710 are presented that, when activated, display product information related to the sales model component 510E—namely, “Sales Prices,” “Sales Texts,” “Foreign Trade Export,” “Picking and Delivery,” and “Taxes.” Similarly, the show control of the financial model component 510F results in an additional control “Valuation Prices.” Once a show control is activated, a hide control represented by a minus sign is presented in place of the show control. For example, the hide control 712 is presented for the financial model component 510F. The activation of one of the additional controls causes the display of appropriate information in detail display 520. For example, when the “Sales Prices” control is selected, sale price information related to the producer is displayed in detail display 720. When the “Valuation Price” control is selected, valuation price information related to the product is displayed in detail display 520.

As illustrated in user interfaces 500, 600 and 700 of FIGS. 5-7, the model 510 is displayed in each display, and, as such, is visible to orient the user and provide the ability to navigate to another model component from any display. Also, as illustrated by user interface 700, the activated model component for which data is displayed in detail panel 720 is highlighted (as shown by sales model component 510E in FIG. 7). This also helps to orient the user displaying the model-based navigation pattern user interface.

A user interface based on a generally known model facilitates a user's comprehension of product data available in a computer system. The model-based navigation pattern may be familiar to a user apart from experience with the computer application from which the user is interacting, and thus, the model-based navigation pattern may be said to support the mental model of the user. In this example, Michael Porter's value chain model is used to enable a user to understand data available related to a particular product and to display the available data. In some implementations, a navigation pattern user interface may be used to review, enter and edit product data.

Although the techniques have been described with respect to displaying information related to a product, the techniques are applicable to displaying information to a service.

The techniques can be implemented in digital electronic circuitry, or in computer hardware, firmware, software, or in combinations of them. The invention can be implemented as a computer program product, i.e., a computer program tangibly embodied in an information carrier, e.g., in a machine-readable storage device, in machine-readable storage medium, in a computer-readable storage device, in computer-readable storage medium, or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the invention by operating on input data and generating output. Method steps can also be performed by, and apparatus of the invention can be implemented as, special purpose logic circuitry, e.g., a FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices, magnetic disks, such as, internal hard disks or removable disks; magneto-optical disks; and CD-ROM and DVD-ROM disks. The processor and the memory can be supplemented by, or incorporated in special purpose logic circuitry.

To provide for interaction with a user, the techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide of interaction with a user as well; for example, feedback provided to the user can be any form of sensory feedback, e.g., visual feedback, auditory feedback, or tactile feedback; and input from the user can be received in any form, including acoustic, speech, or tactile input.

A number of implementations of the techniques have been described. Nevertheless, it will be understood that various modifications may be made without departing from the spirit and scope of the claims. For example, useful results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A computer-readable medium having embodied thereon a computer program having instructions that, when executed, cause a processor to:
display, on a computer display device, a model panel in a computer user interface, the model panel corresponding to one of an academic model or an industry model and including model components;
receive user input requesting access to information related to one of the model components; and
display, on the computer display device, information related to the one of the model components in a second panel in the computer user interface such that the second panel and the model panel are able to be viewed concurrently in the computer user interface.

2. The medium of claim 1 further comprising instructions that, when executed, cause the processor to:
receive user input requesting access to information related to a second model component of the model components;
cease to display the second panel; and
display, on the computer display device, information related to the second model component in a third panel in the computer user interface such that the third panel and the model panel are able to be viewed concurrently in the computer user interface.

3. The medium of claim 2 wherein information related to each of the model components is accessible to be displayed when the model panel is able to be viewed in the computer user interface.

4. The medium of claim 3 wherein each of the model components is operable to display information related to the model component.

5. The medium of claim 1 further comprising instructions that, when executed, cause the processor to;
receive user input identifying a subject of information to be displayed in the computer user interface;
determine whether each model component is able to display information related to the subject of information; and
based on the determination, use a first presentation style for model components for which information related to the subject information is able to be displayed and use a second, different presentation style for model components for which information related to the subject information is not able to be displayed.

6. The medium of claim 1 further comprising instructions that, when executed, cause the processor to display a control proximate to a model component, the control operable to display a subset of information related to the model component.

7. A computer-implemented method for displaying information, the method comprising:
displaying, on a computer display device, a model panel in a computer user interface, the model panel corresponding to one of an academic model or an industry model and including model components;
receiving user input requesting access to information related to one of the model components; and
displaying, on the computer display device, information related to the one of the model components in a second panel in the computer user interface such that the second panel and the model panel are able to be viewed concurrently in the computer user interface.

8. The method of claim 7 further comprising:
receiving user input requesting access to information related to a second model component of the model components;
ceasing to display the second panel; and
displaying, on the computer display device, information related to the second model component in a third panel in the computer user interface such that the third panel and the model panel are able to be viewed concurrently in the computer user interface.

9. The method of claim 8 wherein information related to each of the model components is accessible to be displayed when the model panel is able to be viewed in the computer user interface.

10. The method of claim 9 wherein each of the model components is operable to display information related to the model component.

11. The method of claim 7 further comprising:
receiving user input identifying a subject of information to be displayed in the computer user interface;
determining whether each model component is able to display information related to the subject of information; and
based on the determination, using a first presentation style for model components for which information related to the subject information is able to be displayed and use a second, different presentation style for model components for which information related to the subject information is not able to be displayed.

12. The method of claim 7 further comprising displaying a control proximate to a model component, the control operable to display a subset of information related to the model component.

13. A computer system for displaying information, the system comprising one or more processors configured to:
display, on a computer display device, a model panel in a computer user interface, the model panel corresponding to one of an academic model or an industry model and including model components;
receiving user input requesting access to information related to one of the model components; and
displaying, on the computer display device, information related to the one of the model components in a second panel in the computer user interface such that the second panel and the model panel are able to be viewed concurrently in the computer user interface.

14. The system of claim 13 wherein the one or more processors are further configured to:
receive user input requesting access to information related to a second model component of the model components;
cease to display the second panel; and
display, on the computer display device, information related to the second model component in a third panel in the computer user interface such that the third panel and the model panel are able to be viewed concurrently in the computer user interface.

15. The system of claim 14 wherein information related to each of the model components is accessible to be displayed when the model panel is able to be viewed in the computer user interface.

16. The system of claim 15 wherein each of the model components is operable to display information related to the model component.

17. The system of claim 13 wherein the one or more processors are further configured to:
receive user input identifying a subject of information to be displayed in the computer user interface;
determine whether each model component is able to display information related to the subject of information; and
based on the determination, use a first presentation style for model components for which information related to the subject information is able to be displayed and use a second, different presentation style for model components for which information related to the subject information is not able to be displayed.

18. The system of claim 13 wherein the one or more processors are further configured to display a control proximate to a model component, the control operable to display a subset of information related to display device the model component.
